(19) United States
(12) Patent Application Publication
(10) Pub. No.: US 2026/0095617 A1
(43) Pub. Date: Apr. 2, 2026

(54) CONTROL BOX AND DISPLAY DEVICE INCLUDING THE SAME

(71) Applicant: LG ELECTRONICS INC., Seoul (KR)

(72) Inventors: Juhun LEE, Seoul (KR); Sungwan HONG, Seoul (KR)

(73) Assignee: LG ELECTRONICS INC., Seoul (KR)

(21) Appl. No.: 19/341,443

(22) Filed: Sep. 26, 2025

(30) Foreign Application Priority Data
Sep. 30, 2024 (KR) PCT/KR2024/014826

(51) Int. Cl. H04N 21/426; H01Q 1/22

(52) U.S. Cl. CPC H04N 21/42607; H01Q 1/22

(57) ABSTRACT

A control box including a case which has a first opening with an open one side; an outer top which has a second opening aligned with the first opening of the case, and covers a periphery of the first opening of the case; an inner top which covers the second opening, and rotates with respect to the outer top; an antenna module which is coupled to the inner top within the case; and a bracket which is coupled to the inner top within the case, and has a portion overlapping with the outer top.

### CROSS-REFERENCE TO RELATED APPLICATIONS

Pursuant to 35 U.S.C. § 119, this application claims the benefit of earlier filing date and right of priority to International Application No. PCT/KR2024/014826, filed on September 30, 2024, the contents of which is hereby incorporated by reference herein in its entirety.

### TECHNICAL FIELD

This disclosure relates to a control box and a display device including the same.

### BACKGROUND

As the information society develops, the demand for display devices is also increasing in various forms. In response to this, various display devices such as Liquid Crystal Display Device (LCD), Organic Light Emitting Diodes (OLED), and Micro LED have been researched and used in recent years.

Among these, the LCD panel has a TFT substrate and a color substrate that are opposite to each other with a liquid crystal layer interposed therebetween, and may display images by using light provided from a backlight unit. In addition, an OLED panel may display images by depositing an organic layer that can emit light naturally on a substrate on which a transparent electrode is formed. In particular, a display device equipped with an OLED panel has the advantage of being able to be implemented in an ultra-thin form because it does not require a backlight unit.

A control box can be used separately from the display device, while being adjacent to a user. The control box can provide various information to the display device. For example, the control box may be an AV box. The control box can exchange information with a display head equipped with a display panel that displays an image, by wire/wireless.

Recently, much research has been conducted on the connectivity of such a control box and the display device.

### SUMMARY

The disclosure has been made in view of the above problems, and may provide a display device that communicates wirelessly with a control box.

The disclosure may further provide a rotation mechanism for a communication module provided in a control box.

The disclosure may further provide a waterproof structure for a control box in which a communication module is rotatable.

In accordance with an aspect of the present disclosure, a control box includes: a case which has a first opening with an open one side; an outer top which has a second opening aligned with the first opening of the case, and covers a periphery of the first opening of the case; an inner top which covers the second opening, and rotates with respect to the outer top; an antenna module which is coupled to the inner top within the case; and a bracket which is coupled to the inner top within the case, and has a portion overlapping with the outer top.

The display device may include: a display panel; a frame to which the display panel is coupled; and a communication module which is coupled to the frame, and wirelessly communicates with an antenna module of the control box.

### BRIEF DESCRIPTION OF THE DRAWINGS

The above and other objects, features and advantages of the present invention will be more apparent from the following detailed description in conjunction with the accompanying drawings, in which:

FIGS. 1 to 12 are drawings illustrating examples of a control box and a display device including the same according to embodiments of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be denoted by the same reference numbers, and description thereof will not be repeated.

In general, suffixes such as “module” and “unit” may be used to refer to elements or components. Use of such suffixes herein is merely intended to facilitate description of the specification, and the suffixes do not have any special meaning or function.

In the present disclosure, that which is well known to one of ordinary skill in the relevant art has generally been omitted for the sake of brevity. The accompanying drawings are used to assist in easy understanding of various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are only used to distinguish one element from another.

It will be understood that when an element is referred to as being “connected with” another element, there may be intervening elements present. In contrast, it will be understood that when an element is referred to as being “directly connected with” another element, there are no intervening elements present

A singular representation may include a plural representation unless context clearly indicates otherwise.

In the present application, it should be understood that the terms “comprises, includes,” “has,” etc. specify the presence of features, numbers, steps, operations, elements, components, or combinations thereof described in the specification, but do not preclude the presence or addition of one or more other features, numbers, steps, operations, elements, components, or combinations thereof.

The direction indications of up U, down D, left Le, right Ri, front F, and rear R shown in the drawings are only for the convenience of explanation, and the technical concepts disclosed in this specification are not limited thereby.

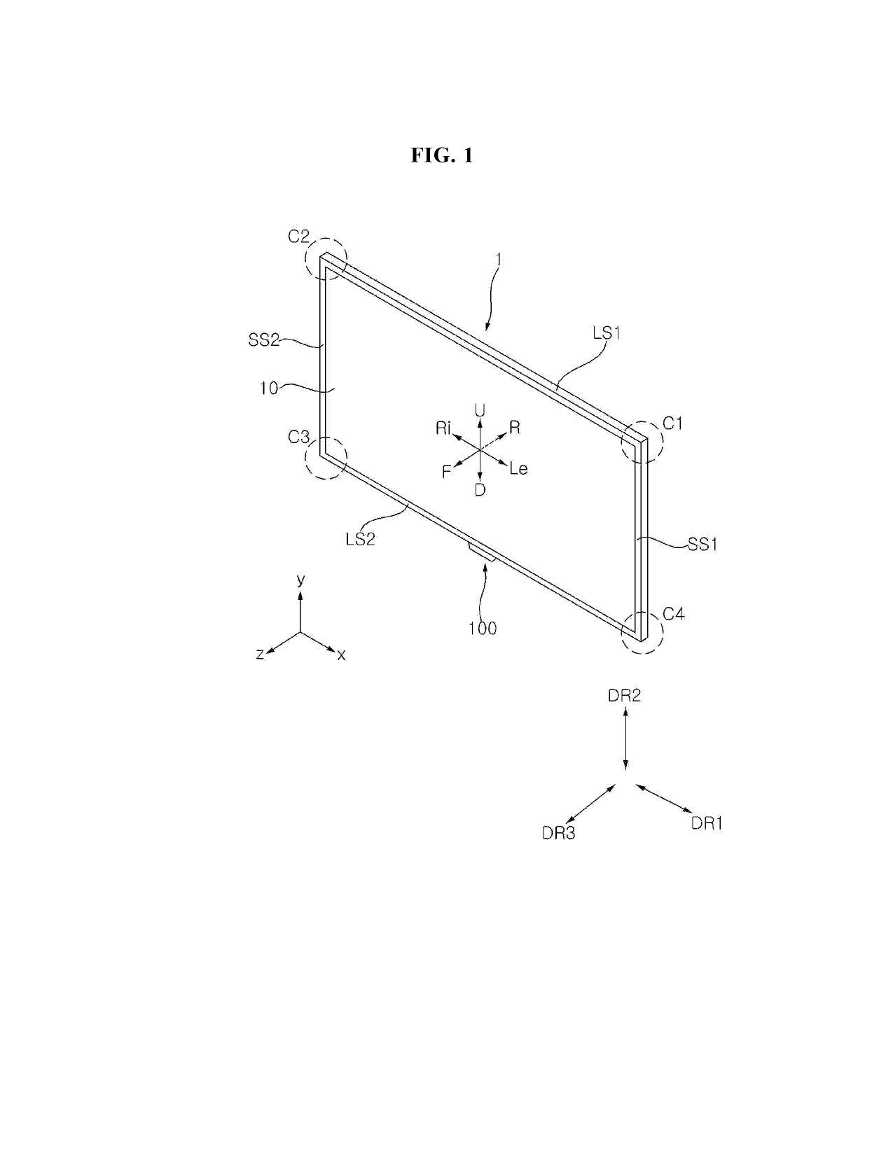

Referring to FIG. 1, a display device 1 may include a display panel 10. The display panel 10 may display an image on a front surface.

The display 1 may include a first long side LS1, a second long side LS2 opposite to the first long side LS1, a first short side SS1 adjacent to the first long side LS1 and the second long side LS2, and a second short side SS2 opposite to the first short side SS1. Meanwhile, for convenience of explanation, it is illustrated that the lengths of the first and second long sides LS1 and LS2 are longer than the lengths of the first and second short sides SS1 and SS2, but it may be possible that the lengths of the first and second long sides LS1 and LS2 are approximately the same as the lengths of the first and second short sides SS1 and SS2.

The direction parallel to the long sides LS1, LS2 of the display device 1 may be referred to as a left-right direction or a first direction DR1. The direction parallel to the short sides SS1, SS2 of the display device 1 may be referred to as an up-down direction or a second direction DR2. The direction perpendicular to the long sides LS1, LS2 and the short sides SS1, SS2 of the display device 1 may be referred to as a front-rear direction or a third direction DR3.

The direction in which the display panel 10 displays an image may be referred to as a forward direction (F, z), and the opposite direction may be referred to as a rearward direction (R, -z). The first long side LS1 side may be referred to as an upper side (U, y). The second long side LS2 side may be referred to as a lower side (D, -y). The first short side SS1 side may be referred to as a left side (Le, x). The second short side SS2 side may be referred to as a right side (Ri, -x).

The first long side LS1, the second long side LS2, the first short side SS1, and the second short side SS2 may be referred to as an edge of the display device 1. In addition, a point where the first long side LS1, the second long side LS2, the first short side SS1, and the second short side SS2 meet each other may be referred to as a corner.

For example, a point where the first short side SS1 and the first long side LS1 meet may be referred to as a first corner C1. A point where the first long side LS1 and the second short side SS2 meet may be referred to as a second corner C2. A point where the second short side SS2 and the second long side LS2 meet may be referred to as a third corner C3. A point where the second long side LS2 and the first short side SS1 meet may be referred to as a fourth corner C4.

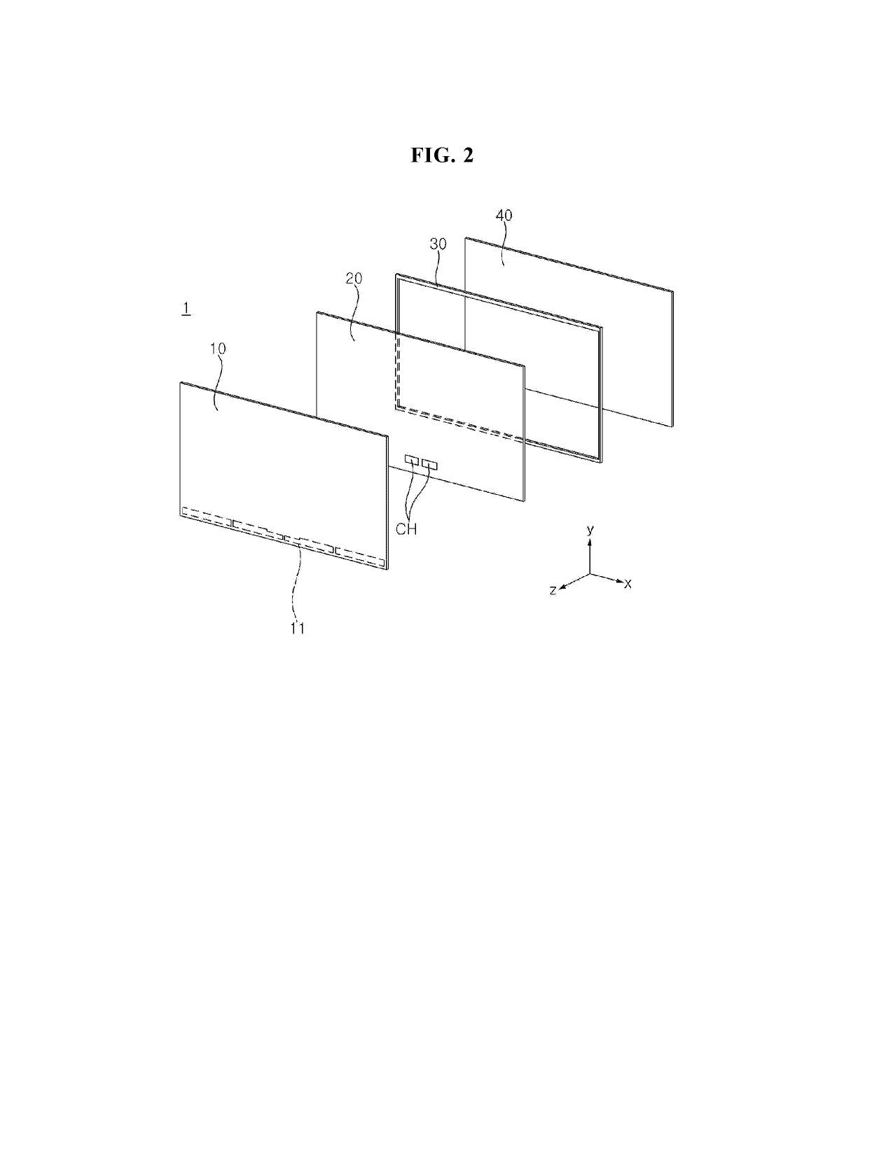

Referring to FIGS. 1 and 2, the display device 1 may include a display panel 10, a frame 20, a side frame 30, and a back cover 40.

The display panel 10 may form the front surface of the display device 1 and may display an image in a forward direction. For example, the display panel 10 may be an Organic Light Emitting Diode (OLED) panel. However, the display panel applicable to the present disclosure is not limited to an OLED panel. The display panel 10 may divide an image into a plurality of pixels and output an image by adjusting the color, brightness, and saturation for each pixel. The display panel 10 may be divided into an active area where an image is displayed and a de-active area where an image is not displayed. The display panel 10 may generate light corresponding to the color of red, green, or blue according to a control signal.

The frame 20 may be positioned at the rear of the display panel 10, and the display panel 10 may be coupled to the frame 20. For example, the frame 20 may include a metal material. A cable hole CH may be formed by penetrating the frame 20. Meanwhile, the frame 20 may be referred to as a main frame 20 or a module cover 20 or a rear frame 20 or a rear cover 20.

The side frame 30 may extend along the circumference of the frame 20. The frame 20 may be coupled to the side frame 30 at the front or rear of the side frame 30. The side frame 30 may cover the side surface of the display panel 10 and the frame 20. Meanwhile, the side frame 30 may be referred to as a guide panel.

The back cover 40 may be positioned at the rear of the frame 20 and may be coupled to the frame 20. For example, the back cover 40 may be an injection product of a resin material. For another example, the back cover 40 may include a metal material.

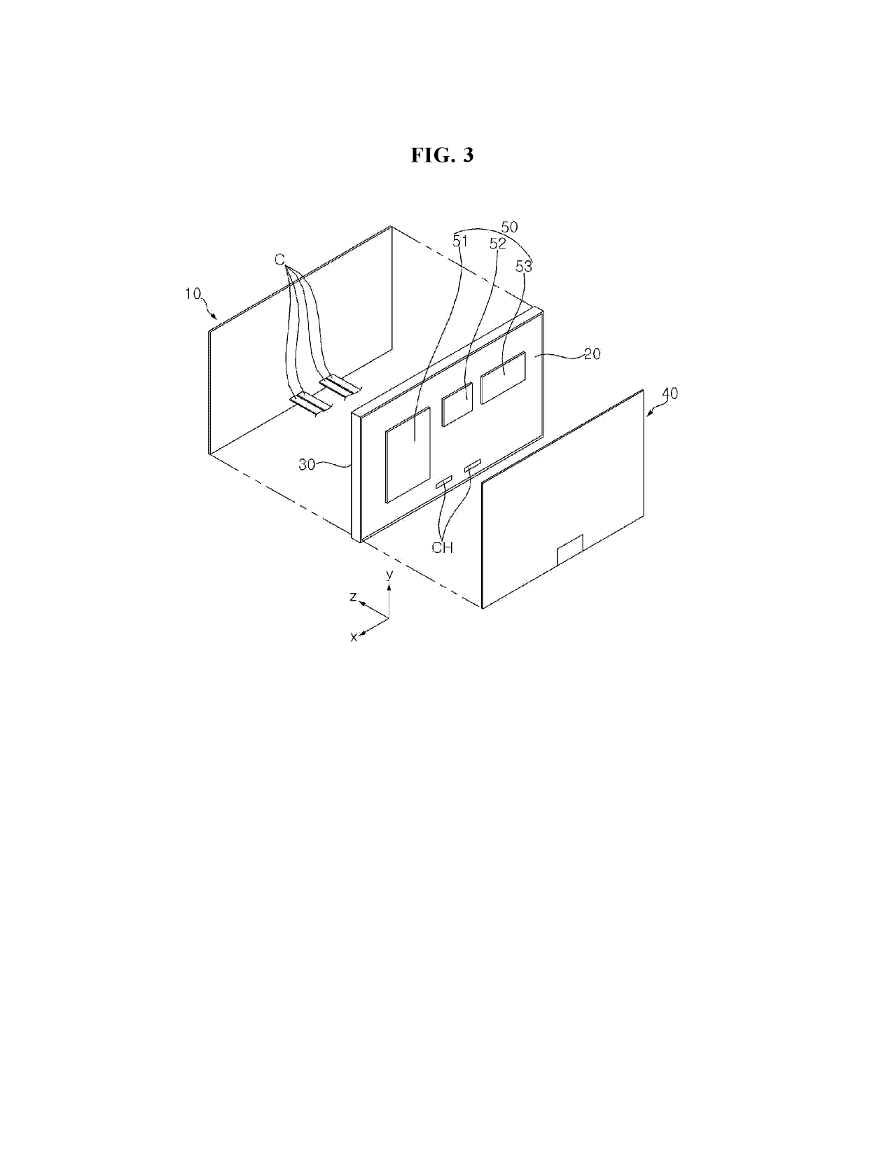

Referring to FIG. 3, boards 50 may be mounted on the frame 20 at the rear of the frame 20. A plurality of electronic components may be mounted on the boards 50. The board 50 may be a Printed Circuit Board (PCB), and may be electrically connected to electronic components of the display device.

For example, the boards 50 may include a power supply board 51 that provides power to each component of the display device, a timing controller board 52 that provides a video signal to the display panel 10, and a main board 53 that provides a video signal to the display panel 10 and/or the timing controller board 52, and controls the display device.

Meanwhile, a Source PCB 11 (S-PCB, see FIG. 2) may be adjacent to the lower side of the display panel 10, and may be coupled to the rear surface of the display panel 10. The cable C may pass through a cable hole CH formed at the lower side of the frame 20, and may connect the S-PCB 11 and the timing controller board 52. Accordingly, the cable C may transmit digital video data and a timing control signal from the timing controller board 52 to the S-PCB 11. For example, the cable C may be a Flexible Flat Cable (FFC).

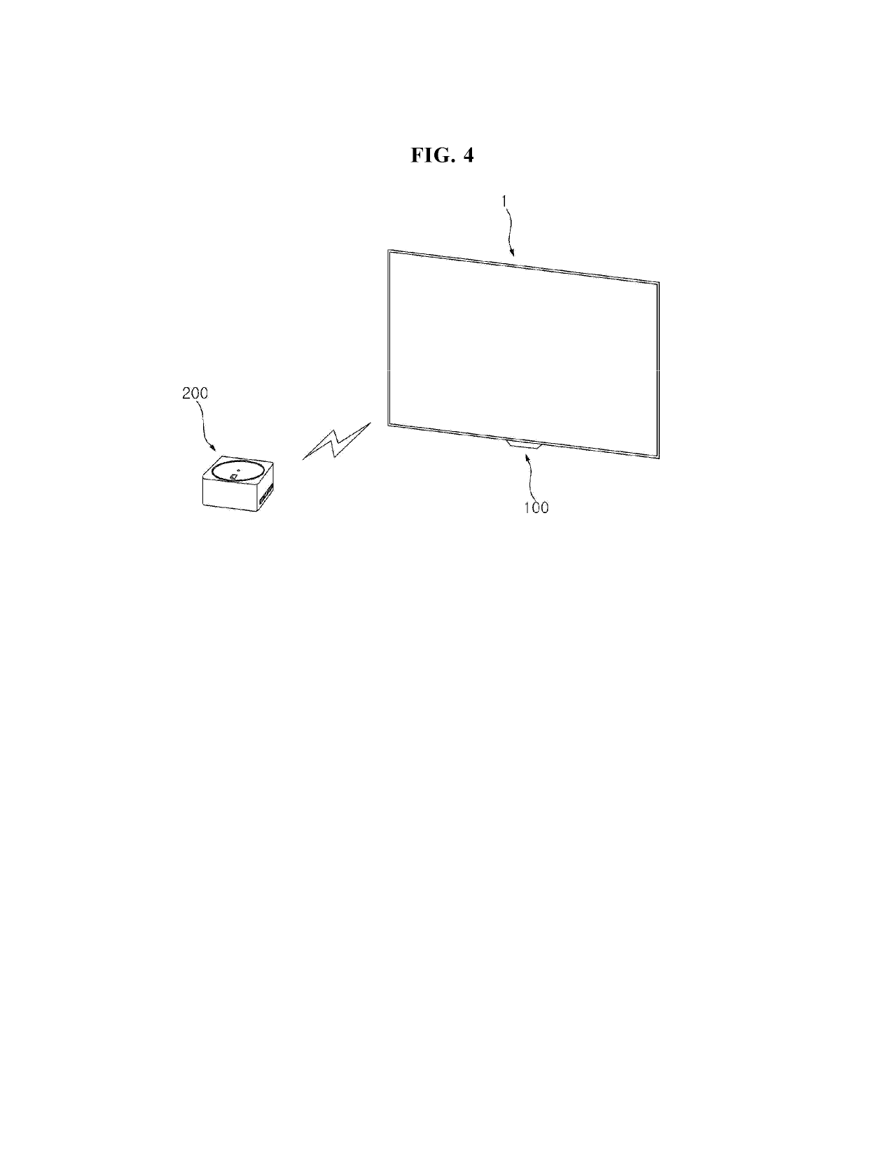

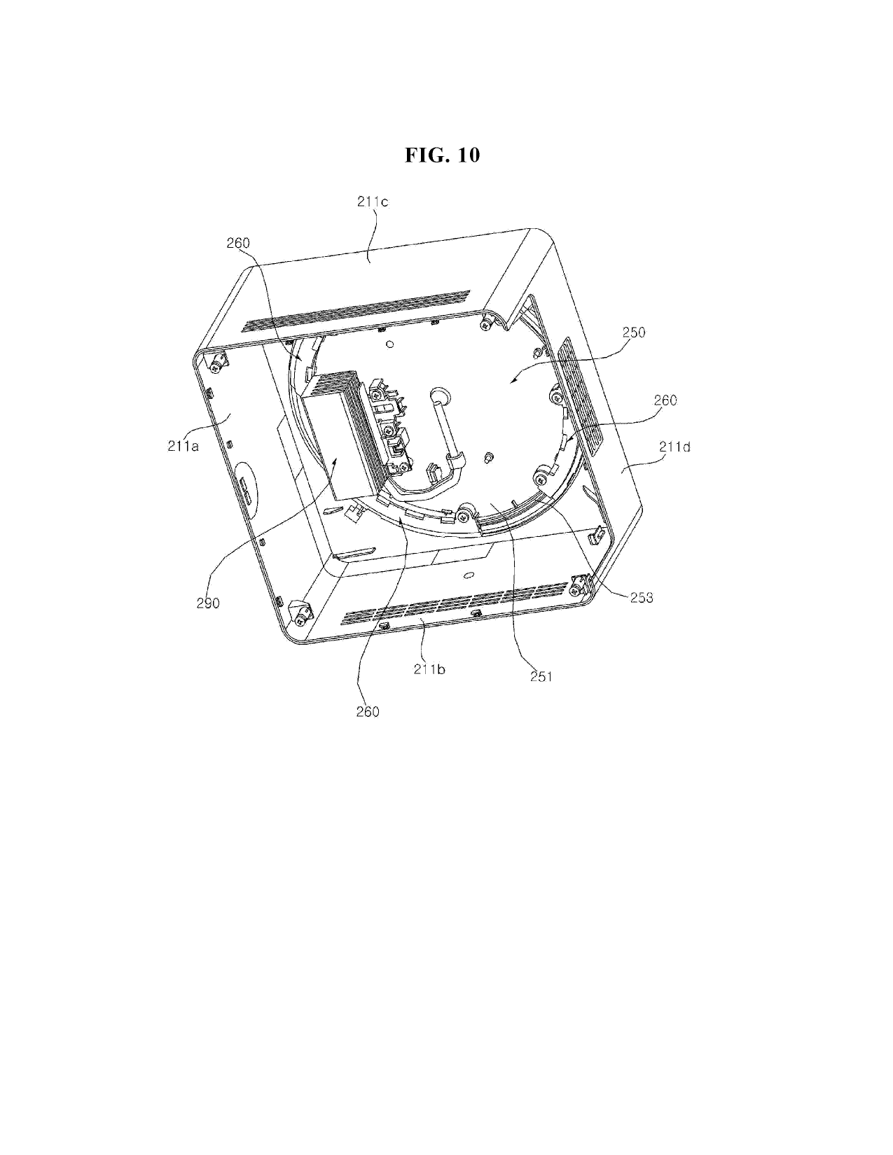

Referring to FIG. 4, the control box 200 may be separated from the display device 1. The control box 200 may be referred to as a set-top box. The control box 200 may wirelessly exchange information with the display device 1. A communication module 290 (see FIG. 10) of the control box 200 may wirelessly communicate with a communication module 100 of the display device 1. At least a portion of the communication module 100 may protrude outward from the edge of the display device 1. Accordingly, the communication module 100 may wirelessly communicate smoothly with the communication module 290 (see FIG. 10) of the control box 200.

The stability of wireless communication between the control box 200 and the display device 1 may vary depending on the relative positions of the control box 200 and the display device 1. The display device 1 may be positioned at a constant location in order to maintain a constant distance from a user. The control box 200 needs to have a high degree of freedom in the location for user convenience.

Meanwhile, the control box 200 may be a component of the display device 1. In this case, the display device 1 including the display panel 10 may be referred to as a head 1.

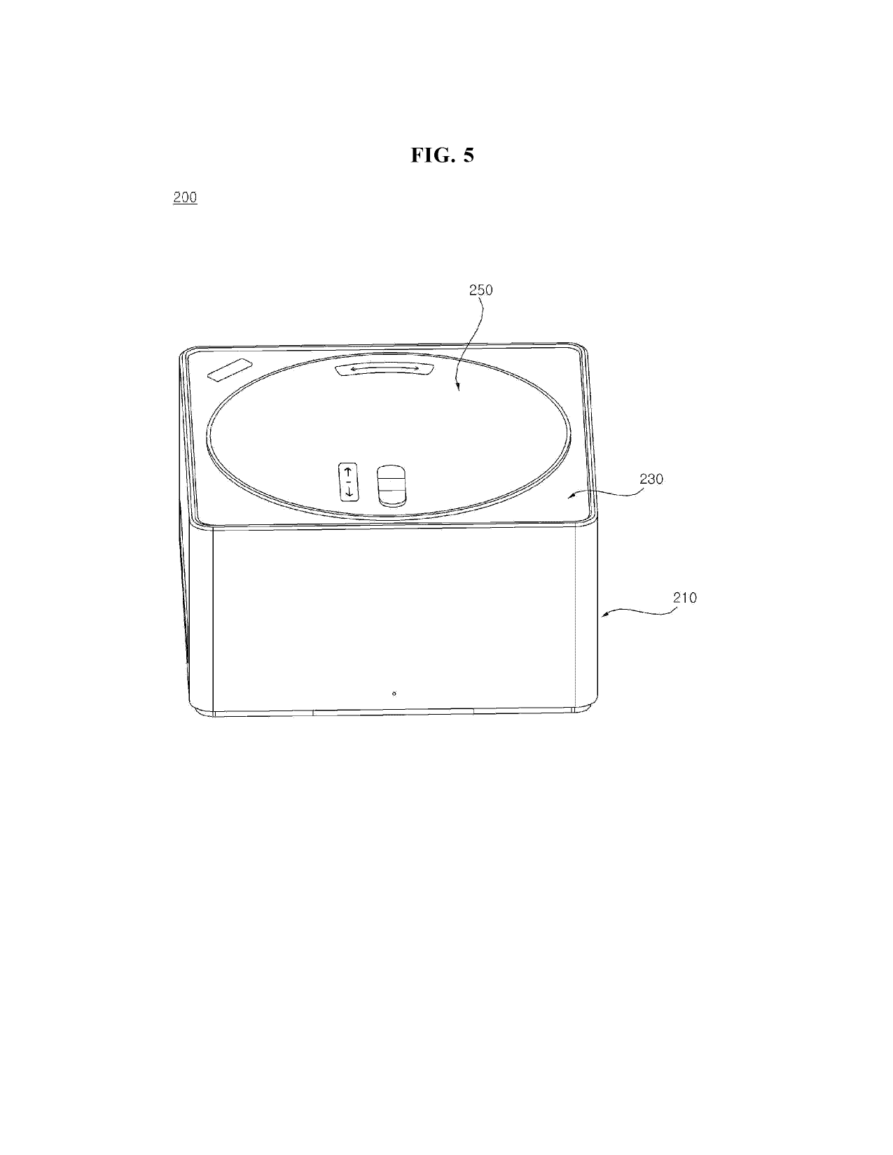

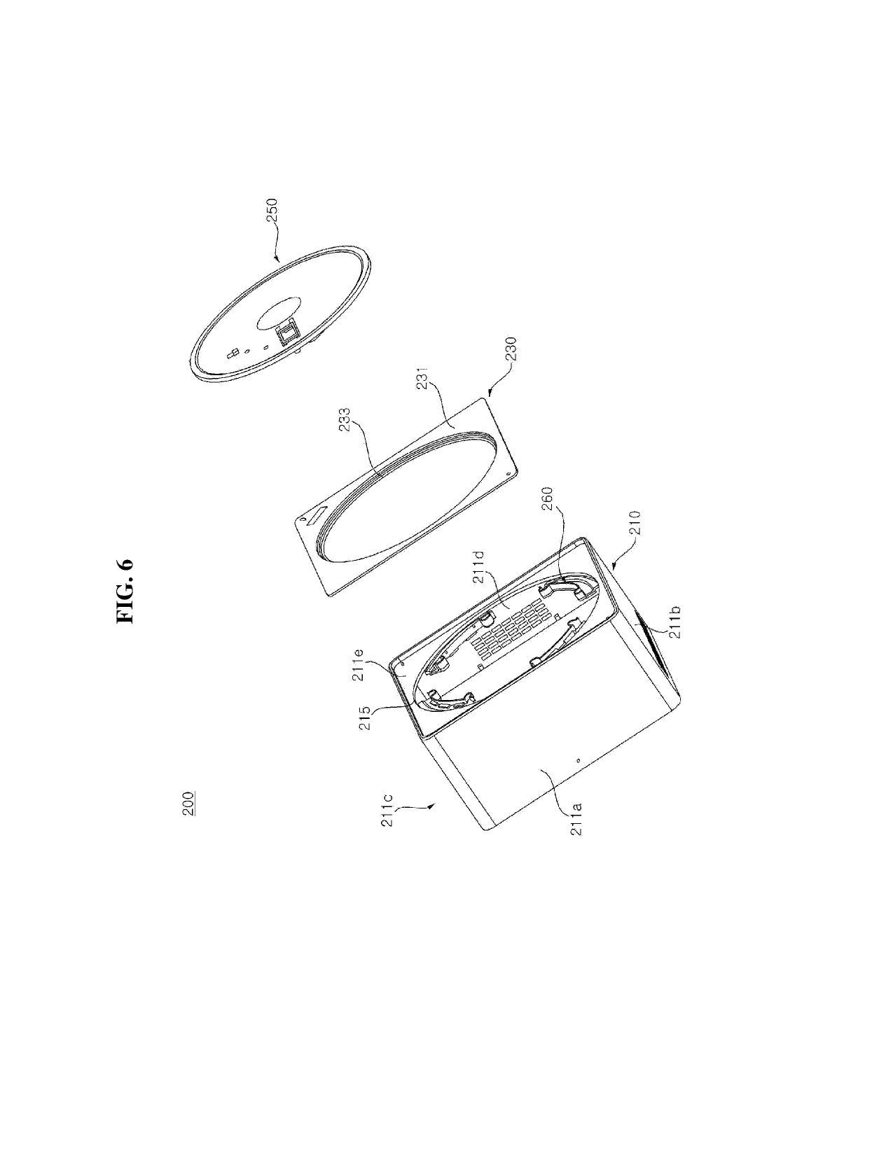

Referring to FIGS. 5 and 6, the control box 200 may include a case 210, an outer top 230, and an inner top 250. The outer top 230 may be referred to as a rotation supporter 230. The inner top 250 may be referred to as a rotation circle 250 or a rotation plate 250.

The case 210 may have a side surface 211a, 211b, 211c, 211d and an upper surface 211e. The side surface 211a, 211b, 211c, 211d of the case 210 may form four surfaces 211a, 211b, 211c, and 211d. The case 210 may include an opening 215. The opening 215 may be formed on the upper surface 211e of the case 210. The opening 215 may be circular.

The outer top 230 may be positioned on the upper surface 211e of the case 211. The outer top 230 may include a top cover 231 and an opening 233. The opening 233 of the outer top 230 may penetrate the top cover 231, and correspond to the opening 215 of the upper surface 211e of the case 210. The opening 233 of the outer top 230 may be circular. The top cover 231 of the outer top 230 may be fixed to the upper surface 211e of the case 210. The outer top 230 may be positioned around the opening 215 of the upper surface 211e of the case 210. The outer top 230 may be formed as one body with the upper surface 211e of the case 210.

The inner top 250 may cover the opening 233 of the outer top 230. The inner top 250 may be circular. The inner top 250 may rotate in the opening 233 of the outer top 230. The inner top 250 may cover the opening 233 of the outer top 230 and/or the opening 215 of the upper surface 211e of the case 210. The inner top 250 may rotate in the opening 233 of the outer top 230.

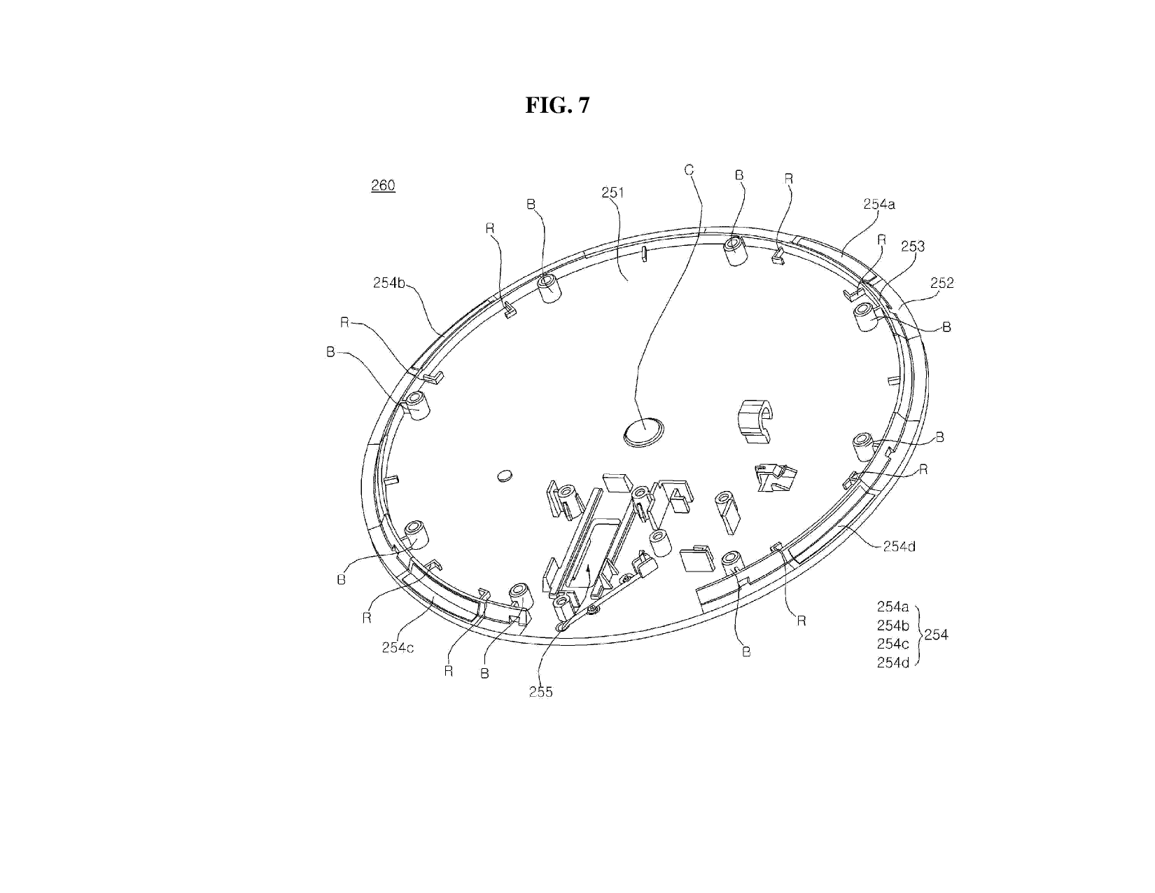

Referring to FIG. 7, the inner top 250 may include a circle plate 251, a ring plate 252, and a circle wall 253. The circle plate 251 may have a disc shape. The ring plate 252 may have a ring shape, and may be formed on the outer circumference of the circle plate 251. The circle wall 253 may partition the circle plate 251 and the ring plate 252. For example, the circle wall 253 may form an obtuse angle with respect to the ring plate 252. For another example, the circle wall 253 may form a right angle with respect to the circle plate 251. The circle wall 253 may be a ring or an open ring having an open portion. A center point C may be positioned at the center of the circle plate 251. The center point C may be the center of rotation of the inner top 250.

An antenna lever hole 255 may be formed to penetrate the circle plate 251. The antenna lever hole 255 may have a rectangular shape. The antenna lever hole 255 may extend in a radial direction of the circle plate 251 from the center point C.

A contact sheet 254 may be fixed or adhered to the ring plate 252 and/or the circle wall 253. The contact sheet 254 may be formed of a low-friction material. For example, the contact sheet 254 may be a Teflon sheet. There may be a plurality of contact sheets 254. A first contact sheet 254a may be positioned opposite to a third contact sheet 254c with respect to the center point C. A second contact sheet 254b may be positioned opposite to a fourth contact sheet 254d with respect to the center point C. The first contact sheet 254a may be positioned between the second contact sheet 254b and the fourth contact sheet 254d.

A coupling rib R may be positioned between the circle plate 251 and the circle wall 253. The coupling rib R may protrude from the circle plate 251. The coupling rib R may be connected to the circle wall 253. For example, the coupling rib R may be L-shaped or I-shaped. A pair of coupling ribs R may be positioned adjacent to both ends of the contact sheet 254, respectively.

A coupling boss B may be formed on the circle plate 251 while being adjacent to the circle wall 253. The coupling boss B may protrude from the circle plate 251. Each of a pair of coupling bosses B may be positioned adjacent to both ends of the contact sheet 254. The pair of coupling ribs R may be positioned between the pair of coupling bosses B.

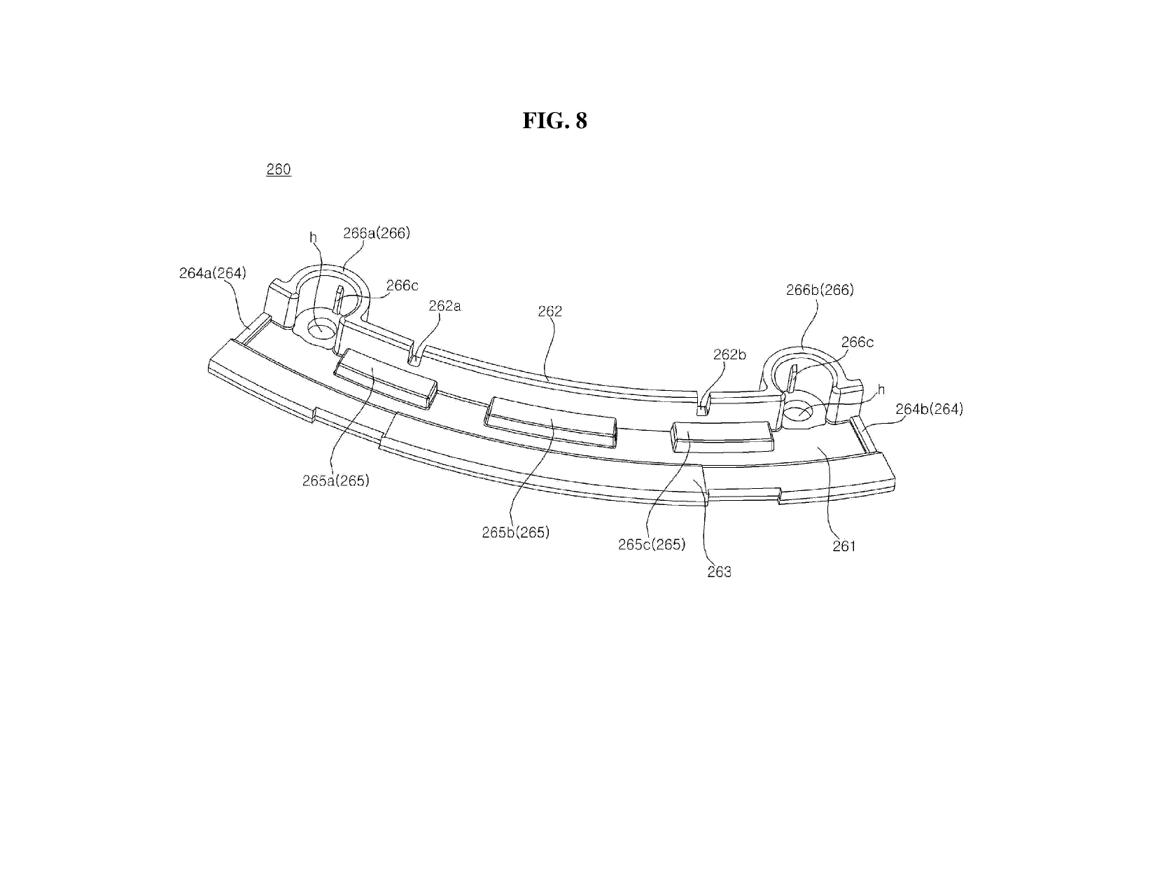

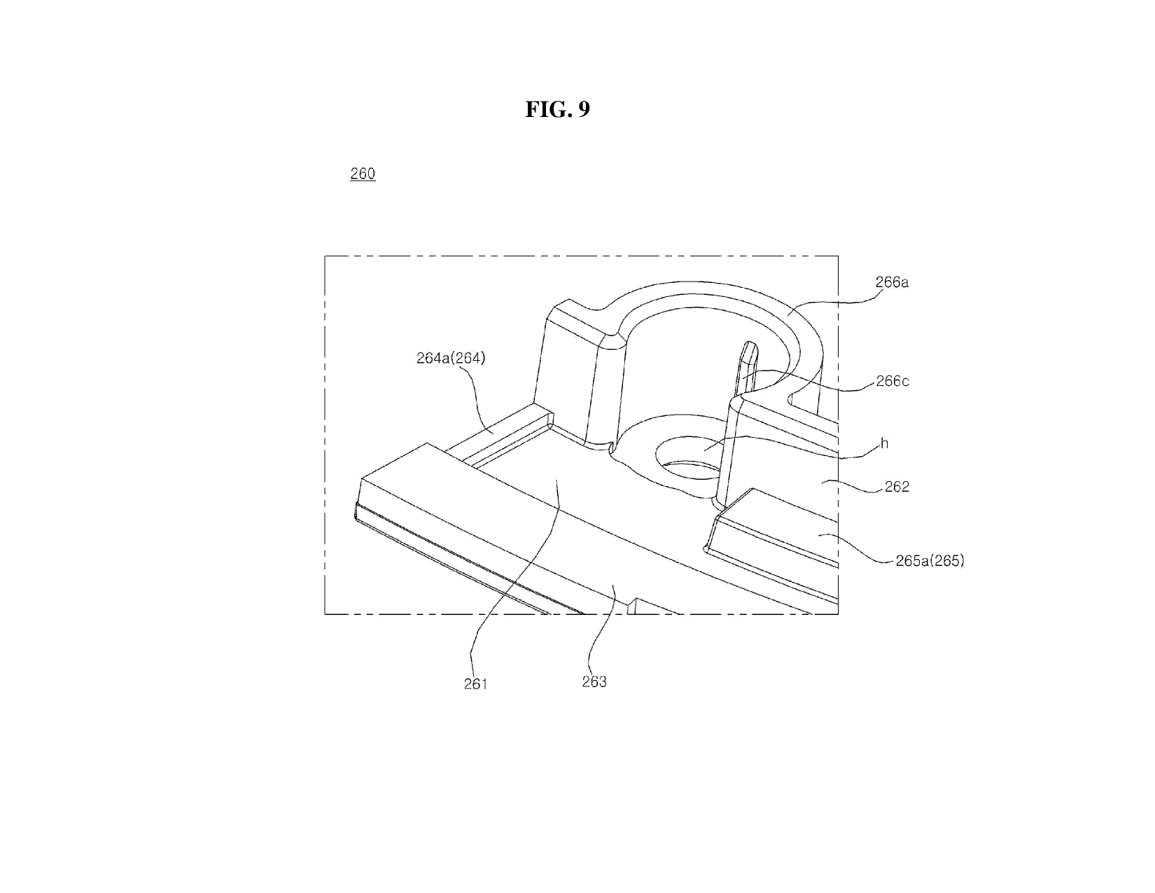

Referring to FIGS. 8 and 9, a bracket 260 may have an overall fan shape. The bracket 260 may be referred to as a top supporter 260 or a rotation bracket 260 or a holder 260. The bracket 260 may include a horizontal part 261, a vertical part 262, and a step part 263.

The horizontal part 261 may form a bottom of the bracket 260. The vertical part 262 may form a wall with respect to the horizontal part 261. A slot 262a, 262b may be formed in the vertical part 262. The slot 262a, 262b may have a shape in which the vertical part 262 is cut out in a downward direction of the vertical part 262 from the upper surface of the vertical part 262. A pair of slots 262a, 262b may be formed in the vertical part 262.

A step part 263 may be positioned opposite to the vertical part 262 with respect to the horizontal part 261. The height of the step part 263 may be lower than the height of the vertical part 262. The step part 263 may form a high step from the horizontal part 261.

A dam barrier 264 may be formed at both ends of the horizontal part 261. A pair of dam barriers 264a, 264b may connect the vertical part 262 and the step part 263. The height of the dam barrier 264 may be lower than the height of the step part 263.

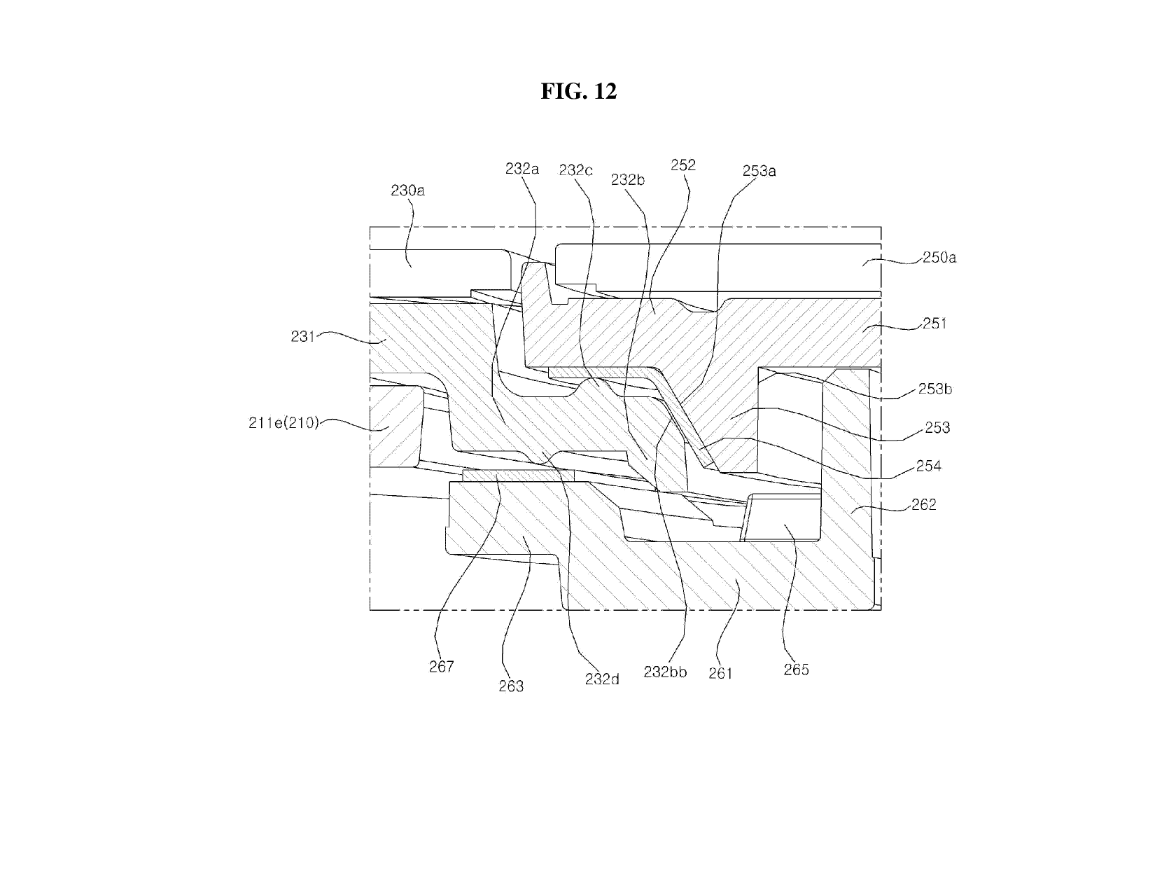

A middle step 265 may be formed in the horizontal part 261. The middle step 265 may be connected to the vertical part 262. The middle step 265 may form a high step from the horizontal part 261. The height of the middle step 265 may be lower than the height of the step part 263, and higher than the height of the dam barrier 264. The middle step 265 may be a plurality of sections 265a, 265b, 265c. The middle step 265 may support the circle wall 253 (see FIG. 12) of the inner top 250 (see FIG. 7).

A coupling hole 266 may be formed in the vertical part 262. A pair of coupling holes 266a, 266b may be formed while being adjacent to both ends of the vertical part 262. The coupling hole 266 may have a cylindrical shape having an open portion. The coupling hole 266 may have a joining hole h formed at the bottom. The coupling hole 266 may be opened toward the horizontal part 261 and/or the step part 263. A guide rib 266c may be formed on the inner surface of the coupling hole 266. The guide rib 266c may extend vertically to the inner surface of the coupling hole 266.

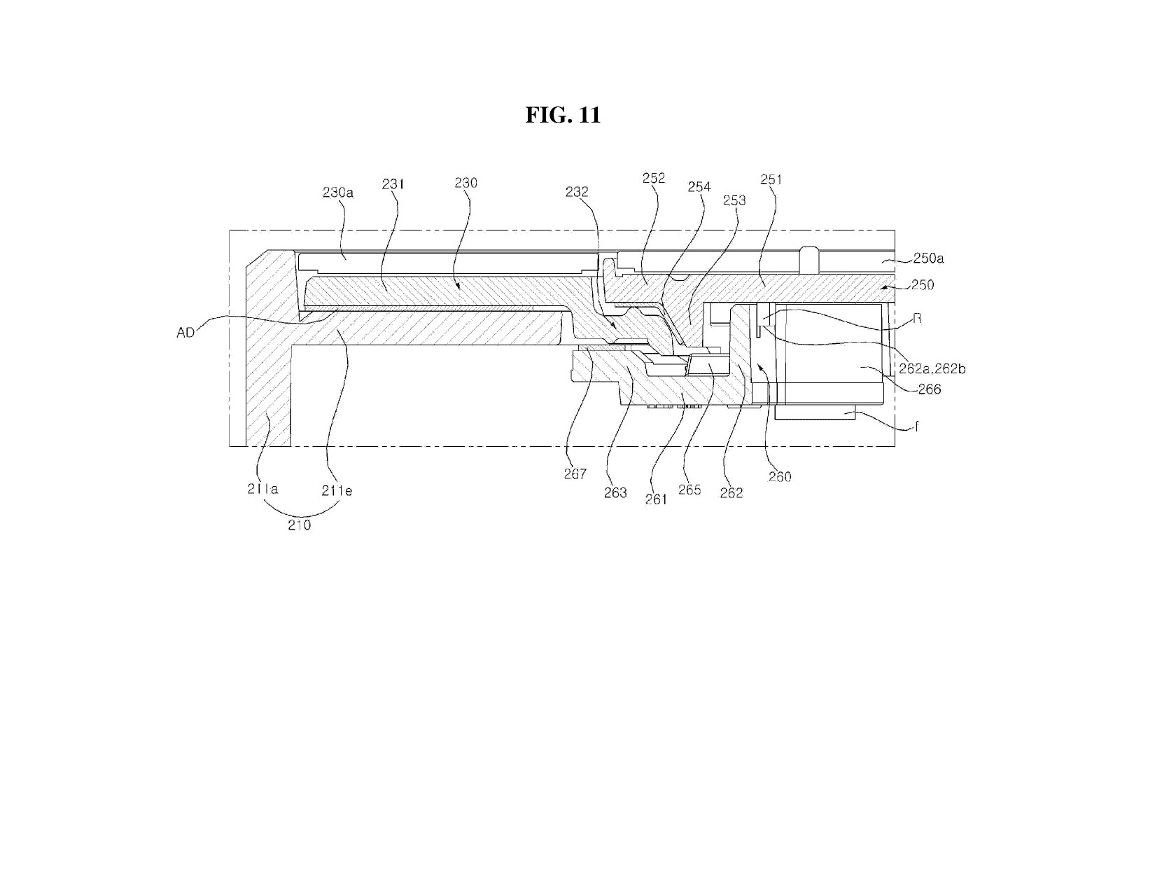

Referring to FIGS. 10 and 11, the outer top 230 may be coupled or fixed to the upper surface 211e of the case 210. The top cover 231 of the outer top 230 may be fixed to the upper surface 211e of the case 210 by an adhesive member AD. An outer top deco 230a may be fixed or adhered to the upper surface of the top cover 231 of the outer top 230.

The outer top 230 may include a top cover 231 and a top supporter 232. The top supporter 232 may form a low step from the top cover 231. The top supporter 232 may form the opening 233 (see FIG. 6) of the outer top 230.

The inner top 250 may cover the opening 233 of the outer top 230. The ring plate 252 and/or the circle wall 253 of the inner top 250 may be supported on the top supporter 232 of the outer top 230. The inner top 250 may rotate on the top supporter 232 of the outer top 230.

The bracket 260 may be coupled or fixed to the lower surface of the inner top 250. The top supporter 232 of the outer top 230 may be positioned between the step part 263 of the bracket 260 and the ring plate 252 of the inner top 250.

The boss B (see FIG. 7) formed on the circle plate 251 of the inner top 250 may be inserted into the coupling hole 266 of the bracket 260, and the fastening member f may be inserted through the joining hole h (see FIG. 8) of the coupling hole 266 of the bracket 260 and fixed to the boss B (see FIG. 7). The coupling rib R of the inner top 250 may be inserted into the slot 262a, 262b of the vertical part 262 of the bracket 260. Accordingly, the inner top 250 and the bracket 260 may be firmly coupled, so that the rotational durability with respect to the outer top 230 of the inner top 250 may be improved.

The antenna module 290 may be coupled to the lower surface of the inner top 250. As the inner top 250 rotates with respect to the outer top 230, the position of the antenna module 290 may be varied. The antenna module 290 may be referred to as a communication module 290.

Referring to FIG. 12 together with FIG. 11, the top supporter 232 of the outer top 230 may include a support rim 232a and a guide rim 232b. The support rim 232a may form a low step from the top cover 231 of the outer top 230. The support rim 232a may include an upper contact part 232c and a lower contact part 232d. The upper contact part 232c may be formed by protruding from the upper surface of the support rim 232a. The lower contact part 232d may be formed by protruding from the lower surface of the support rim 232a. The upper contact part 232c may be referred to as an upper supporter 232c or an upper dam 232c. The lower contact part 232d may be referred to as a lower supporter 232d or a lower dam 232d.

The upper contact part 232c of the support rim 232a may support the ring plate 252 of the inner top 250. The upper contact part 232c may be in contact with the contact sheet 254 fixed to the ring plate 252. The upper contact part 232c of the support rim 232a may have a curved upper surface. The upper contact part 232c of the support rim 232a may come into point contact with or come into line contact with the contact sheet 254 of the ring plate 252 of the inner top 250.

The lower contact part 232d of the support rim 232a may support the step part 263 of the bracket 260. The lower contact part 232d may be in contact with the contact sheet 267 fixed to the step part 263 of the bracket 260. The lower contact part 232d of the support rim 232a may have a curved lower surface. The lower contact part 232d of the support rim 232a may come into point contact with or come into line contact with the contact sheet 267 of the step part 263 of the bracket 260.

Accordingly, the inner top 250 and the bracket 260 may minimize friction while rotating with respect to the top supporter 232 of the outer top 230.

The guide rim 232b may be formed on the inner surface of the support rim 232a. The thickness of the guide rim 232b may be greater than the thickness of the support rim 232a. The guide rim 232b may have an inclined surface 232bb on the inner surface. The inclined surface 232bb of the guide rim 232b may face the inclined surface 253a of the circle wall 253 of the inner top 250. The contact sheet 254 may be positioned between the inclined surface 232bb of the guide rim 232b and the inclined surface 253a of the circle wall 253. The inclined surface 253a of the circle wall 253 may form an acute angle with respect to the vertical surface 253b of the circle wall 253.

Accordingly, the position of the inner top 250 may be aligned. When the inner top 250 rotates on the outer top 230, the rotation center of the inner top 250 may be aligned with the rotation center of the outer top 250.

Moisture may flow in between the ring plate 252 of the inner top 250 and the top cover 231 of the outer top 230. The upper contact part 232c may prevent the flowing moisture from flowing to the bracket 260. If the amount of inflow of moisture is large and exceeds the upper contact part 232c, moisture may accumulate in the horizontal part 261 of the bracket 260. The moisture may be stored without overflowing to the outside of the bracket 260 by the dam barriers 264a, 264b (see FIG. 8) formed at both ends of the horizontal part 261 of the bracket 260 and the step part 263. The moisture accumulated in the bracket 260 may naturally evaporate over time.

Referring to FIGS. 1 to 12, a control box includes: a case which has a first opening with an open one side; an outer top which has a second opening aligned with the first opening of the case, and covers a periphery of the first opening of the case; an inner top which covers the second opening, and rotates with respect to the outer top; an antenna module which is coupled to the inner top within the case; and a bracket which is coupled to the inner top within the case, and has a portion overlapping with the outer top.

The outer top includes: a top cover covering the periphery of the first opening of the case; and a top supporter which forms a low step from an outer surface of the top cover, and forms a second opening of the outer top, and a circumference of the inner top is positioned on the top supporter.

The inner top includes: a circle plate corresponding to the second opening of the outer top; a ring plate which forms a circumference of the circle plate, and is positioned on the top supporter of the outer top; and a circle wall which is formed between the circle plate and the ring plate, and supported by the top supporter of the outer top.

An outer circumferential surface of the circle wall forms an obtuse angle with respect to an outer surface of the ring plate.

The top supporter includes an inclined surface which faces the outer circumferential surface of the circle wall, and supports the outer circumferential surface of the circle wall.

The inner top further includes a contact sheet which is fixed to the outer circumferential surface of the circle wall, and in contact with the inclined surface of the top supporter.

The top supporter includes an upper contact part which protrudes from an outer surface of the top supporter, and supports the ring plate of the inner top.

The inner top further includes a contact sheet which is fixed to the ring plate, and in contact with the upper contact part.

The bracket includes: a vertical part which is coupled to the circle plate; a horizontal part which overlaps with the circle wall; and a step part which overlaps the top supporter of the outer top, and forms a high step from the horizontal part.

A height of the vertical part with respect to the horizontal part is greater than a height of the step part with respect to the horizontal part.

The bracket further includes a dam barrier which protrudes from the horizontal part, and connects the vertical part and the step part.

The bracket further includes a coupling hole having a cylindrical shape formed in the vertical part, and the inner top further includes a boss which is adjacent to the circle wall, formed in the circle plate, and inserted into the coupling hole.

The bracket further includes a slot formed in the vertical part, and the inner top further includes a coupling rib which is adjacent to the circle wall, formed in the circle plate, and inserted into the slot of the vertical part of the bracket.

The bracket further includes a contact sheet fixed to the step part, and the top supporter further includes a lower contact part protruding toward the contact sheet of the step part of the bracket.

The bracket further includes a middle step forming a high step from the horizontal part, and a height of the middle step from the horizontal part is smaller than a height of the step part from the horizontal part. The middle step supports the circle wall of the inner top.

Another control box includes a case which has an opening with an open one side; a rotation plate which covers the opening of the case, and rotates in the opening of the case; an antenna module which is coupled to the rotation plate inside the case; and a bracket which is coupled to the rotation plate inside the case, and has a portion overlapping with the case.

The bracket includes: a vertical part which is coupled to the rotation plate; a horizontal part which extends from the vertical part in a radial direction of the rotation plate, and overlaps with the rotation plate; and a step part which overlaps with a circumference of the opening of the case, and forms a high step from the horizontal part.

A height of the vertical part with respect to the horizontal part is greater than a height of the step part with respect to the horizontal part.

The bracket further includes a dam barrier which protrudes from the horizontal part, and connects the vertical part and the step part.

The bracket further includes a slot formed in the vertical part, and the rotation plate further includes a coupling rib inserted into the slot of the vertical part of the bracket.

The effects of the control box according to the present disclosure and the display device having the same are described as follows.

According to at least one of the embodiments of the present disclosure, a display device that communicates wirelessly with a control box can be provided.

According to at least one of the embodiments of the present disclosure, a rotation mechanism for a communication module provided in a control box can be provided.

According to at least one of the embodiments of the present disclosure, a waterproof structure for a control box in which a communication module is rotatable can be provided.

Certain embodiments or other embodiments of the invention described above are not mutually exclusive or distinct from each other. Any or all elements of the embodiments of the invention described above can be combined or combined with each other in configuration or function.

For example, a configuration “A” described in one embodiment of the invention and the drawings and a configuration “B” described in another embodiment of the invention and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A control box comprising:
a case which has a first opening with an open one side;
an outer top which has a second opening aligned with the first opening of the case, and covers a periphery of the first opening of the case;
an inner top which covers the second opening, and rotates with respect to the outer top;
an antenna module which is coupled to the inner top within the case; and
a bracket which is coupled to the inner top within the case, and has a portion overlapping with the outer top.

2. The control box of claim 1, wherein the outer top comprises:
a top cover covering the periphery of the first opening of the case; and
a top supporter which forms a low step from an outer surface of the top cover, and forms a second opening of the outer top,
wherein a circumference of the inner top is positioned on the top supporter.

3. The control box of claim 2, wherein the inner top comprises:
a circle plate corresponding to the second opening of the outer top;
a ring plate which forms a circumference of the circle plate, and is positioned on the top supporter of the outer top; and
a circle wall which is formed between the circle plate and the ring plate, and supported by the top supporter of the outer top.

4. The control box of claim 3, wherein an outer circumferential surface of the circle wall forms an obtuse angle with respect to an outer surface of the ring plate.

5. The control box of claim 4, wherein the top supporter comprises an inclined surface which faces the outer circumferential surface of the circle wall, and supports the outer circumferential surface of the circle wall.

6. The control box of claim 5, wherein the inner top further comprises a contact sheet which is fixed to the outer circumferential surface of the circle wall, and in contact with the inclined surface of the top supporter.

7. The control box of claim 3, wherein the top supporter comprises an upper contact part which protrudes from an outer surface of the top supporter, and supports the ring plate of the inner top.

8. The control box of claim 7, wherein the inner top further comprises a contact sheet which is fixed to the ring plate, and in contact with the upper contact part.

9. The control box of claim 3, wherein the bracket comprises:
a vertical part which is coupled to the circle plate;
a horizontal part which overlaps with the circle wall; and
a step part which overlaps the top supporter of the outer top, and forms a high step from the horizontal part.

10. The control box of claim 9, wherein a height of the vertical part with respect to the horizontal part is greater than a height of the step part with respect to the horizontal part.

11. The control box of claim 10, wherein the bracket further comprises a dam barrier which protrudes from the horizontal part, and connects the vertical part and the step part.

12. The control box of claim 10, wherein the bracket further comprises a coupling hole having a cylindrical shape formed in the vertical part,
wherein the inner top further comprises a boss which is adjacent to the circle wall, formed in the circle plate, and inserted into the coupling hole.

13. The control box of claim 12, wherein the bracket further comprises a slot formed in the vertical part,
wherein the inner top further comprises a coupling rib which is adjacent to the circle wall, formed in the circle plate, and inserted into the slot of the vertical part of the bracket.

14. The control box of claim 9, wherein the bracket further comprises a contact sheet fixed to the step part,
wherein the top supporter further comprises a lower contact part protruding toward the contact sheet of the step part of the bracket.

15. The control box of claim 14, wherein the bracket further comprises a middle step forming a high step from the horizontal part,
wherein a height of the middle step from the horizontal part is smaller than a height of the step part from the horizontal part,
wherein the middle step supports the circle wall of the inner top.

16. A control box comprising:
a case which has an opening with an open one side;
a rotation plate which covers the opening of the case, and rotates in the opening of the case;
an antenna module which is coupled to the rotation plate inside the case; and
a bracket which is coupled to the rotation plate inside the case, and has a portion overlapping with the case.

17. The control box of claim 16, wherein the bracket comprises:
a vertical part which is coupled to the rotation plate;
a horizontal part which extends from the vertical part in a radial direction of the rotation plate, and overlaps with the rotation plate; and
a step part which overlaps with a circumference of the opening of the case, and forms a high step from the horizontal part.

18. The control box of claim 17, wherein a height of the vertical part with respect to the horizontal part is greater than a height of the step part with respect to the horizontal part.

19. The control box of claim 17, wherein the bracket further comprises a dam barrier which protrudes from the horizontal part, and connects the vertical part and the step part.

20. The control box of claim 19, wherein the bracket further comprises a slot formed in the vertical part,
wherein the rotation plate further comprises a coupling rib inserted into the slot of the vertical part of the bracket.
